(19) United States
(12) Patent Application Publication
(10) Pub. No.: US 2009/0211457 A1
(43) Pub. Date: Aug. 27, 2009

(54) BEVERAGE PERCOLATOR

(76) Inventor: Virginio Cortese, Torino (IT)

Correspondence Address: LADAS & PARRY LLP, 26 WEST 61ST STREET, NEW YORK, NY, 10023, US

(21) Appl. No.: 12/281,499

(22) PCT Filed: Mar. 2, 2007
(86) PCT No.: PCT/IB07/00499

§ 371 Date: Jan. 22, 2009

(30) Foreign Application Priority Data
Mar. 3, 2006 (IT) TO2006U000029

(51) Int. Cl. A47J 31/00

(52) U.S. Cl. 99/289 R; 99/323

(57) ABSTRACT

A beverage percolating machine having an outer body or casing housing a rotor, which is fitted removably to a shaft to rotate in steps about a substantially horizontal, fixed axis of rotation, and has a number of peripheral percolating cups, each for receiving a respective measure of powdered material; the outer casing has a door facing the rotor to permit access to and, if necessary, removal and/or maintenance of the rotor.

### TECHNICAL FIELD

The present invention relates to a beverage percolating machine.

More specifically, the present invention relates to a beverage percolating machine comprising an outer body or casing, a shaft rotating in steps about a respective fixed axis, and a rotor fitted to and rotating in steps with the shaft about said axis; the shaft and rotor being housed inside the outer casing; and the rotor having a number of peripheral percolating cups, each for receiving a respective measure of powdered material.

### BACKGROUND ART

One example of a percolating machine of the above type is described and illustrated in the Applicant's Patent Application PCTEPO553334, to which full reference is made herein for the sake of clarity.

The rotor of machines of this type calls for frequent cleaning and maintenance, to do which, the whole of the usually cup-shaped outer casing must normally be detached from the base of the machine and removed for access to the rotor.

### DISCLOSURE OF INVENTION

It is an object of the present invention to improve a machine of the type described above, to simplify cleaning and maintenance of the rotor.

According to the present invention, there is provided a beverage percolating machine, as claimed in Claim 1 and, preferably, in any one of the following Claims depending directly or indirectly on Claim 1.

### BRIEF DESCRIPTION OF THE DRAWINGS

A number of non-limiting embodiments of the invention will be described by way of example with reference to the accompanying drawings, in which:

FIG. 1 shows a schematic view in perspective of the machine according to the present invention in the closed configuration;

FIG. 2 shows a schematic view in perspective of the machine according to the present invention in the open configuration;

FIG. 3 shows a partly exploded view in perspective of a detail of the FIG. 1 machine;

FIG. 4 shows a side view of the FIG. 3 detail;

FIG. 5 shows an exploded front view of the FIG. 3 detail;

FIGS. 6 and 7 show two axial sections of a detail in FIG. 3;

FIG. 8 shows an axial section of a variation of the FIG. 6 detail.

### BEST MODE FOR CARRYING OUT THE INVENTION

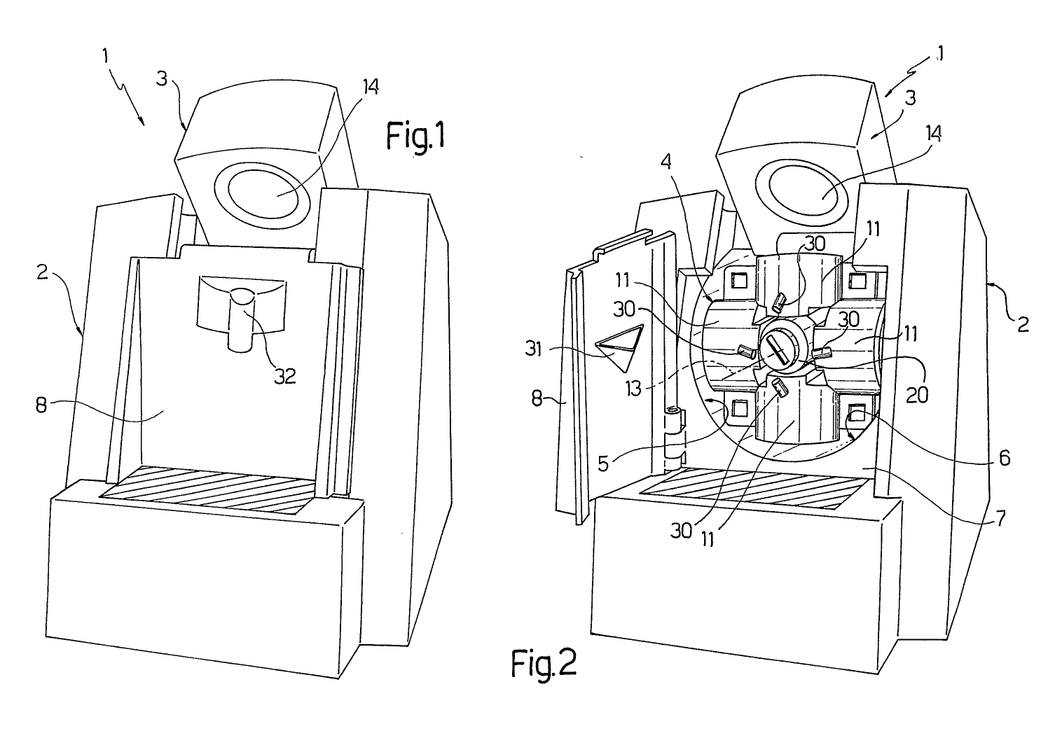

Number 1 in FIGS. 1 and 2 indicates as a whole a coffee percolating machine.

Machine 1 is bounded externally by a body comprising a contoured casing 2; and a lift-up lid 3 movable between a raised rest position (FIGS. 1 and 2) and a lowered work position (not shown).

As shown schematically in FIG. 2, machine 1 comprises a rotor 4 housed in casing 2 inside a substantially cylindrical cavity 5 having a wafer or capsule discharge lateral opening not shown. Cavity 5 is accessible from the outside through an opening 6 formed through a substantially vertical front wall 7 of casing 2 and closed by a door 8 hinged to wall 7 to rotate between a closed position (FIG. 1), in which door 8 is substantially parallel to wall 7 and cavity 5 is completely covered, and an open position (FIG. 2), in which door 8 is swung outwards and opening 6 is fully exposed.

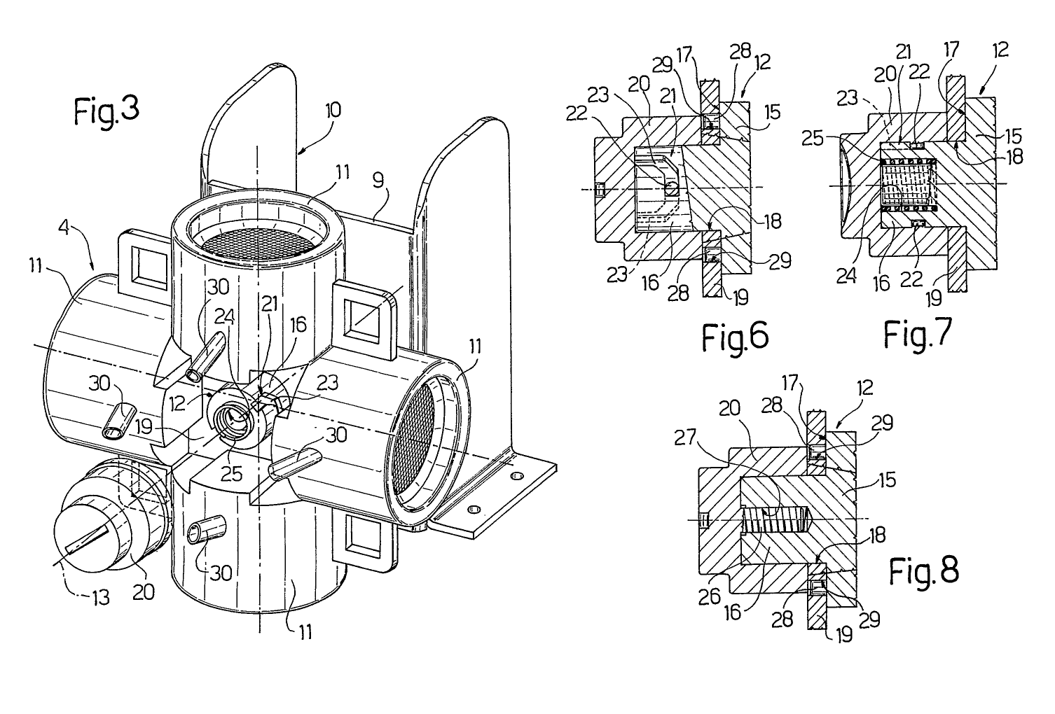

With reference to FIGS. 3, 4 and 5, rotor 4 is fitted removably to and projects from a substantially vertical wall 9 of a supporting bracket 10, and has four peripheral percolating cups 11 arranged in twos opposite each other, and each for housing a respective known wafer or capsule (not shown) containing a measure of ground coffee.

Rotor 4 is fitted to an end portion of a shaft 12 fitted through wall 9 and rotating about a substantially horizontal, fixed axis 13 to move cups 11 in steps along a circular path coaxial with axis 13, so as to selectively set each cup 11 to an infusion position, in which cup 11 is positioned with its concavity facing upwards to cooperate, when lid 3 is in the lowered position (not shown), with a pressurized-hot-water sprinkler 14 in lid 3, and define, with sprinkler 14, a fluidtight percolating chamber.

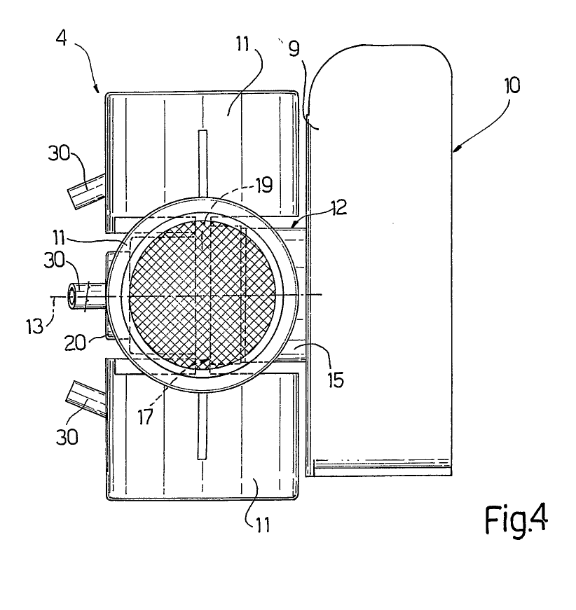

As shown clearly in FIGS. 4 and 6-8, shaft 12 comprises an end portion 15 projecting outwards of wall 9 of bracket 10 towards opening 6, and terminating with a cylindrical appendix 16, which is coaxial with axis 13 and defines, on end portion 15, an annular shoulder 17 facing opening 6 and coaxial with axis 13.

Appendix 16 extends in sliding manner through a hole 18 formed, coaxially with axis 13, through a central plate 19 of rotor 4, and the free end of appendix 16 facing opening 6 is engaged in rotary and axially sliding manner by a cap 20, which locks plate 19 axially against shoulder 17 to lock rotor 4 axially to shaft 12.

More specifically, with reference to the FIG. 6 and 7 embodiment, cap 20 is locked to the end of appendix 16 by a bayonet joint 21 comprising two diametrically opposite pins 22, which are connected to a cylindrical lateral wall of cap 20, project radially from the lateral wall towards axis 13, and engage respective L-shaped grooves 23, each of which is formed on the end of appendix 16 and comprises an inlet portion substantially parallel to axis 13 and open at the end of appendix 16 to permit insertion of relative pin 22, and an end portion substantially crosswise to axis 13.

As shown in FIG. 7, the free end of appendix 16 has a dead hole 24 coaxial with axis 13 and defining the seat of a helical spring 25, which projects axially outwards of hole 24 when cap 20 is detached from appendix 16 (FIG. 3), and which is compressed between hole 24 and a bottom wall of cap 20 when cap 20 is fitted to appendix 16 (FIG. 7). In the latter position, spring 25 exerts detachment pressure axially on cap 20 to prevent pins 22 from sliding along the transverse end portions of respective grooves 23, and so prevent accidental rotation of cap 20 about axis 13.

In the FIG. 8 variation, as opposed to a bayonet joint 21, cap 20 is locked to appendix 16 by a screw connection comprising a threaded pin 26, which is connected to the bottom wall of cap 20, coaxially with axis 13, and engages a threaded dead hole 27 formed axially in the free end of appendix 16.

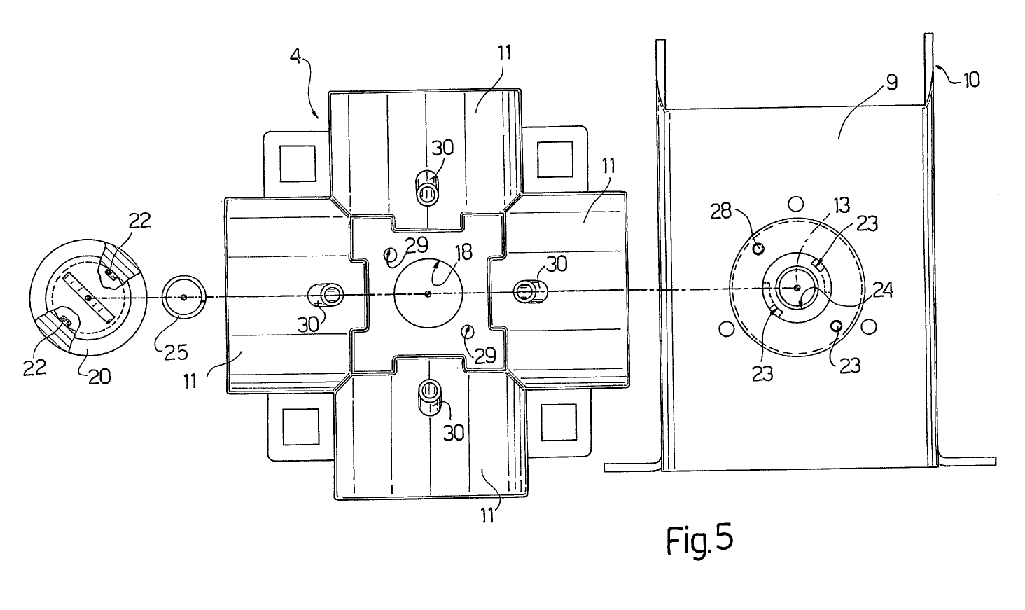

Rotor 4 is locked angularly to shaft 12 by two pins 28 (FIGS. 5, 6, 8) which project, parallel to axis 13, from shoulder 17 towards opening 6, are equidistant from and diametrically opposite with respect to axis 13, and engage in sliding manner respective through holes 29 formed in plate 19 and parallel to axis 13.

Each cup 11 of rotor 4 has a respective discharge nozzle 30, which, when cup 11 is in the infusion position described above, is aligned with a catch cup 31 connected to an inner surface of door 8 (FIG. 2) and communicating with a discharge nozzle 32 on the outside of door 8 (FIG. 1).

During normal operation of machine 1, door 8 is in the closed position shown in FIG. 1.

When routine cleaning or servicing of rotor 4 is required, the user, after turning off machine 1, opens door 8, removes cap 20 manually from the end of appendix 16, and, pulling slightly in the axial direction, removes rotor 4 from shaft 12 to detach it completely from the rest of machine 1. In this connection, it should be pointed out that opening 6 is sized to permit easy axial withdrawal of rotor 4.

Once cleaning and/or servicing are/is completed, the user reassembles rotor 4 by simply aligning hole 18 with appendix 16, and holes 29 with respective pins 28, and sliding rotor 4 axially along appendix 16, so that plate 19 rests against shoulder 17, and pins 28 are inserted inside respective holes 29, thus locking rotor 4 angularly about axis 13.

At this point, rotor 4 is locked axially by the user simply fitting cap 20 onto the end of appendix 16, and locking the cap 20 manually by engaging bayonet joint 21 (in the FIG. 6 or 7 embodiment) or by screwing threaded pin 26 inside hole 27 (in the FIG. 8 embodiment). In this connection, it should be pointed out that cap 20 may be provided (as shown in the drawings) with a transverse slot formed on the outside of its bottom wall, and in which to insert a thin object, such as a coin, to assist in tightening cap 20 to the end of appendix 16, especially in the case of the screw connection in FIG. 8.

Once cap 20 is locked, door 8 is closed, and machine 1 is ready to operate once more.

The advantage of the present invention will be clear from the foregoing description.

Door 8 in front wall 7 of machine 1 allows access to rotor 4 with no need to detach outer casing 2 from machine 1, so that cleaning and servicing of rotor 4 are easier and faster, and, at least in many cases, can be carried out by the user of machine 1, with no technical assistance required.

Finally, being connected removably, rotor 4 can be removed completely from the rest of machine 1 for easier, more through cleaning or maintenance of rotor 4.

1) A beverage percolating machine comprising an outer body or casing (2), a shaft (12) rotating in steps about a respective fixed axis (13), and a rotor (4) fitted to the shaft (12) to rotate in steps with the shaft (12) about said axis (13); the shaft (12) and rotor (4) being housed inside the outer casing (2); the rotor (4) having a number of peripheral percolating cups (11), each for receiving a respective measure of powdered material; and the machine (1) being characterized in that the outer casing (2) comprises an opening (6) facing the rotor (4) and allowing direct access to the rotor (4); the outer casing (2) comprising a door (8) for closing the opening (6).

2) A machine as claimed in claim 1, wherein the rotor (4) is fitted removably to the shaft (12); the opening (6) being sized to permit withdrawal of the rotor (4) from the outer casing (2).

3) A machine as claimed in claim 1 or 2, wherein removable connecting means (20, 21, 26, 28, 29) are provided to connect the rotor (4) to the shaft (12); the removable connecting means (20, 21, 26, 28, 29) facing the opening (6), and being accessible directly from the outside through the opening (6).

4) A machine as claimed in claim 3, wherein the shaft (12) has one end (15) facing the opening (6), and the removable connecting means (20, 21, 26, 28, 29) connect the rotor (4) to said end (15) of the shaft (12).

5) A machine as claimed in claim 4, wherein the removable connecting means (20, 21, 26, 28, 29) comprise angular locking means (28, 29) for locking the rotor (4) angularly with respect to the shaft (12) and axial locking means (20, 21, 26) for locking the rotor (4) axially to the shaft (12).

6) A machine as claimed in claim 5, wherein the rotor (4) has a central plate (19) having a through hole (18) coaxial with said axis (13); and the shaft (12) has, at said end (15), an axial appendix (16) projecting towards the opening (6) and defining, on the shaft (12), an annular shoulder (17) facing the opening (6) and coaxial with said axis (13); the appendix (16) extending in sliding manner through the hole (18); and the axial locking means (20, 21, 26) removably engaging an end portion of the appendix (16) projecting from the plate (19) towards the opening (6) to lock the plate (19) axially against the annular shoulder (17).

7) A machine as claimed in claim 6, wherein the appendix (16) is cylindrical, and the angular locking means (28, 29) comprise two pins (28), which project from the annular shoulder (17) towards the opening (6), are parallel to said axis (13), and engage in sliding manner respective further holes (29) formed in the plate (19) and parallel to said axis (13).

8) A machine as claimed in claim 6 or 7, wherein the appendix (16) has a dead axial hole (24), and the axial locking means (20, 21, 26) comprise a cap (20) fitted in rotary and axially sliding manner to said end portion of the appendix (16), and connected to the appendix (16) by a bayonet joint (21).

9) A machine as claimed in claim 8, wherein a helical spring (25) is fitted inside the dead axial hole (24) to cooperate with a bottom wall of the cap (20).

10) A machine as claimed in claim 6 or 7, wherein the appendix (16) has a threaded dead axial hole (27), and the axial locking means (20, 21, 26) comprise a cap (20) fitted in rotary and axially sliding manner to said end portion of the appendix (16); the cap (20) having a bottom wall fitted with a screw (26) engaging the threaded dead axial hole (27).

11) A machine as claimed in one of the foregoing claims, wherein the outer casing (2) comprises a front wall (7); the opening (6) being formed through the front wall (7).

12) A machine as claimed in claim 11, wherein the front wall (7) is substantially vertical, and said axis (13) is horizontal.

13) A machine as claimed in any one of the foregoing claims, and comprising a beverage discharge channel; the discharge channel extending through the door (8), and comprising a catch cup (31) on the inside of the outer casing (2) and a discharge nozzle (32) on the outside of the outer casing (2); and each percolating cup (11) comprising a discharge nozzle (30) alignable selectively with the catch cup (31).
